(19) United States
(12) Patent Application Publication
(10) Pub. No.: US 2025/0265544 A1
(43) Pub. Date: Aug. 21, 2025

(54) FOOD INVENTORY MANAGEMENT SYSTEM AND METHOD

(71) Applicant: MEATSAFE LLC, Castle Rock, CO (US)

(72) Inventor: Steven Ryan Burt, Castle Rock, CO (US)

(21) Appl. No.: 19/057,326

(22) Filed: Feb. 19, 2025

Related U.S. Application Data
(60) Provisional application No. 63/555,360, filed on Feb. 19, 2024.

(51) Int. Cl. G06Q 10/087; G06K 7/14; G06Q 30/018

(52) U.S. Cl. CPC G06Q 10/087; G06K 7/1417; G06Q 30/018

(57) ABSTRACT

The present disclosure provides systems and methods for a food inventory management system including a food inventory management application. The application is configured to receive a plurality of food details associated with a food item that is or will be stored in a food storage cabinet. The food details are used to create digital food record and a scannable code associated with the food item. The food item is then added to a digital food inventory accessible and manageable via the application. The application is also configured to recommend recipes for the food items included in the digital food inventory and monitor expiration dates associated with the food items in the digital food inventory to reduce, if not eliminate, the incidence of wasted food items. The application is also configured to connect multiple users of the application to promote exchange and donation of food items.

### CROSS-REFERENCE TO RELATED APPLICATION

This application claims priority to and the benefit of the filing date of U.S. Provisional Application No. 63/555,360, filed Feb. 19, 2024, the entire disclosure of which is hereby incorporated herein by reference.

### FIELD OF THE DISCLOSURE

This disclosure relates in general to food inventory management systems and methods, and specifically, to a food inventory management system that includes a mobile application that tracks food inventory stored in a freezer.

### BACKGROUND

Each year, an estimated one hundred billion pounds of food is wasted in the United States alone, which equates to over four hundred billion United States dollars in food waste. This food waste occurs at every stage of food production and distribution, including at the stages where the food is farmed, packed, shipped, manufactured, sold, and stored and consumed in homes. According to some statistics, nearly half of all food waste occurs in the home. Some of the main factors contributing to food waste in the home include outdated storage solutions, lack of organization within and associated with those storage solutions, and a disconnect between food need and resources available.

The present disclosure provides food inventory management systems and methods that provide improved organization and storage solutions and facilitate a reduction in food waste.

### BRIEF DESCRIPTION OF THE DRAWINGS

FIG. 1 illustrates a food inventory management system including a food storage cabinet and a food inventory management program, according to one or more embodiments of the present disclosure;

FIG. 2 illustrates a data flow associated with the food inventory management system of FIG. 1, according to one or more embodiments of the present disclosure;

FIG. 3A illustrates a scannable code generated using the food inventory management system of FIG. 1 being scanned using the food inventory management program, according to one or more embodiments of the present disclosure;

FIG. 3B illustrates a second embodiment of the scannable code of FIG. 3A, according to one or more embodiments of the present disclosure;

FIG. 4 illustrates a home screen associated with the food inventory management program of FIG. 1, according to one or more embodiments of the present disclosure;

FIG. 5 illustrates a digital food inventory including one or more food items associated with the food inventory management program of FIG. 1, according to one or more embodiments of the present disclosure;

FIG. 6A illustrates a recipe catalog associated with the food inventory management program of FIG. 1, the recipe catalog including one or more recipes associated with the one or more food items of the digital food inventory, according to one or more embodiments of the present disclosure;

FIG. 6B illustrates a recipe of the recipe catalog of FIG. 6A, according to one or more embodiments of the present disclosure;

FIG. 7A illustrates a notification associated with the food inventory management program of FIG. 1, the notification including a meal idea, according to one or more embodiments of the present disclosure;

FIG. 7B illustrates another notification associated with the food inventory management program of FIG. 1, the another notification including an expiration warning, according to one or more embodiments of the present disclosure;

FIG. 8 illustrates a map including a provision connection network, according to one or more embodiments of the present disclosure;

FIG. 9 illustrates a method of operating the food inventory management system of FIG. 1, according to one or more embodiments of the present disclosure; and

FIG. 10 illustrates a node for implementing one or more example embodiments of the present disclosure, according to one or more embodiments of the present disclosure.

### DETAILED DESCRIPTION

The systems and methods disclosed herein provide improvements to the systems and methods used for food inventory management. It is to be understood that that the present disclosure provides many different embodiments, or examples, for implementing different features of various embodiments. Specific examples of components and arrangements are described below to simplify the present disclosure. These are, of course, merely examples and are not intended to be limiting.

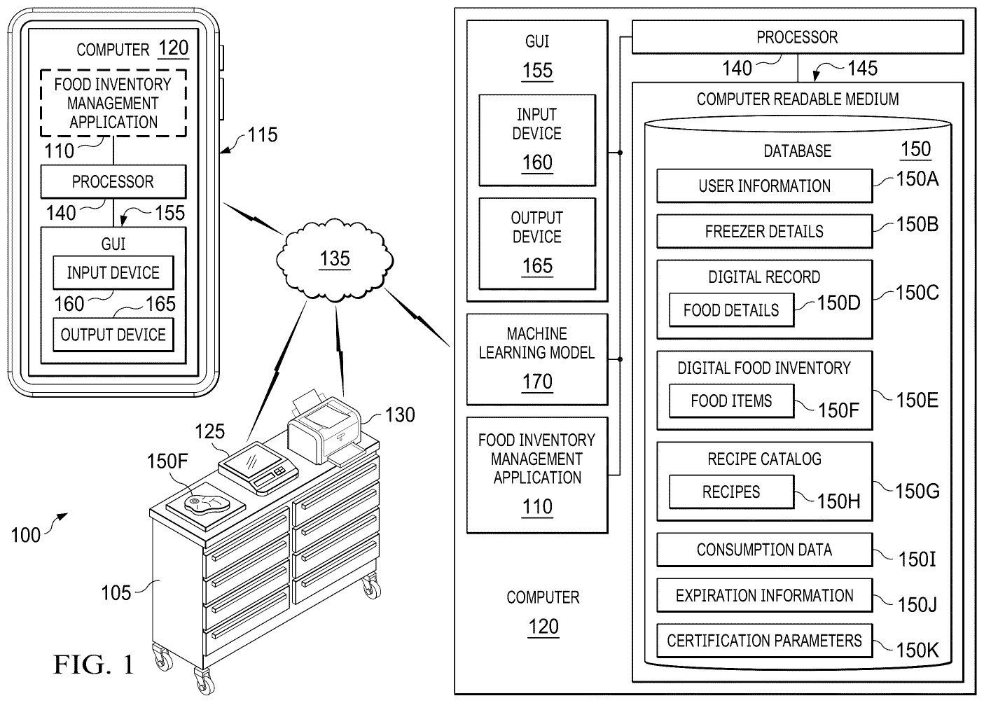

FIG. 1 illustrates a food inventory management system 100, according to one or more embodiments. In one or more embodiments, the food inventory management system 100 includes a food storage cabinet 105, a mobile application, such as, for example, a food inventory management application 110, a user device 115, and a computer 120. In one or more embodiments, the food inventory management system 100 may further include a scale 125 and a printer 130. In one or more embodiments, the food storage cabinet 105, the scale 125, and the printer 130 are separate physical components but in other embodiments, the food storage cabinet 105, the scale 125, and/or the printer 130 are one unit. In one or more embodiments, the food storage cabinet 105, the food inventory management application 110, the computer 120, the scale 125 and the printer 130 may all be in communication with each other via a network 135.

In one or more embodiments, the network 135 may include the Internet, one or more local area networks, one or more wide area networks, one or more cellular networks, one or more wireless networks, one or more voice networks, one or more data networks, one or more communication systems, and/or any combination thereof. In some embodiments, the network may also include Wi-Fi®, Bluetooth®, and Long-Term Evolution (“LTE”) or other wireless broadband communication technology.

In one or more embodiments, the computer 120 includes a computer processor 140 and a computer readable medium 145 operably coupled thereto. Instructions accessible to, and executable by, the computer processor 140 are stored on the computer readable medium 145. A database 150 is also stored in the computer readable medium 145. In one or more embodiments, the database 150 may store data associated with, for example, user information 150A, freezer details 150B, a digital record 150C including a plurality of food details 150D, a digital food inventory 150E including a plurality of food items 150F, a recipe catalog 150G including a plurality of recipes 150H, consumption data 1501, expiration information 150J, and certification parameters 150K. In one or more embodiments, the computer 120 further includes a graphical user interface (“GUI”) 155 including an input device 160 and an output device 165. In one or more embodiments, the input device 160 may include a camera, which may be a digital camera configured to capture still photographs and/or video. In one or more embodiments, the input device 160 may include a keyboard, mouse, microphone, or other device coupled to the user device 115 that sends instructions to the user device 115. In one or more embodiments, a user may provide a plurality of inputs to the computer 120 via the input device 160. In an example embodiment, the input device 160 and the output device 165 include a graphical display, which, in several example embodiments, is in the form of, or includes, a touch screen display, one or more digital displays, one or more liquid crystal displays, and/or any combination thereof. In an example embodiment, the output device 165 includes a graphical display, a printer, a plotter, and/or any combination thereof. In an example embodiment, the input device 160 is the output device 165, and the output device 165 is the input device 160. In one or more embodiments, the GUI 155 is configured to display a plurality of windows or screens to a user.

In one or more embodiments, the computer 120 may also include a machine learning model 170 stored thereon, which may be used to evaluate and make predictions based on the data stored in the database 150.

In one or more embodiments, the computer 120 may be remote from the user device 115. In one or more embodiments, the user device 115 may include a computer including one or more components of the computer 120. In one or more embodiment, the user device 115 may include the computer 120. In one or more embodiments, the computer 120 may be the user device 115.

In one or more embodiments, the user device 115 may be, or include, a telephone, a smart phone, a tablet computer, a personal computer, a personal digital assistant, a cellular telephone, other types of telecommunications devices, other types of computing devices, and/or any combination thereof.

In one or more embodiments, a portion of the food inventory management application 110 is stored in the computer readable medium 145 of the computer 120 of the user device 115. Another portion may be stored in a cloud storage platform or on a server that is remote from the user device 115. In some embodiments, the food inventory management application 110 includes and/or executes one or more web-based programs, Intranet-based programs, and/or any combination thereof. In an example embodiment, the food inventory management application 110 includes a computer program including a plurality of instructions, data, and/or any combination thereof. In an example embodiment, the application is written in, for example, Hypertext Markup Language (HTML), Cascading Style Sheets (CSS), JavaScript, Extensible Markup Language (XML), asynchronous JavaScript and XML (Ajax), iOS, XCode, Swift, Android for mobile, and/or any combination thereof. In an example embodiment, the food inventory management application 110 is a web-based application written in, for example, Java or Adobe Flex, which pulls real-time information from the user device 115. In some embodiments, the food inventory management application 110 is or includes a mobile front-end application downloaded on the user device 115, and a backend application stored or downloaded on another computer 120, server, or cloud that is remote from the user device 115. In one or more embodiments, the mobile front-end application communicates with the backend application to display data created and pushed by the backend application. In some embodiments, the food inventory management application 110 accesses the input device 160 or the output device 165 of the GUI 155.

In one or more embodiments, the food inventory management system 100 is configured to allow users, such as hunters, homesteaders, food enthusiasts, and other such users, to efficiently store, organize, and track their food items 150F in a digital food inventory 150E across multiple food storage cabinets 105 such that the digital food inventory 150E corresponds to a physical food inventory associated with the food storage cabinet(s) 105.

In one or more embodiments, a user of the user device 115 may access the food inventory management application 110 and input user information 150A via the input device 160 to create a user account associated with that individual user. In one or more embodiments, the user information 150A may include a name, address, username, password, email address, and other identifying information.

In one or more embodiments, one or more users may be given permissions or access to a single user account. For example, in one or more embodiments, a first user of a user account associated with the food inventory management application 110 may be the owner or administrator of the user account, which first user may have full access to all features associated with the user account or the food inventory management application 110 including adding and removing food storage cabinets 105, managing the digital food inventory 150E, generating scannable codes to be printed using the printer 130, accessing compliance records associated with the certification parameters 150K, as well as any other features discussed with respect to other users. In one or more embodiments, a second user may be another member of a household, which second user may be able to use the food inventory management application 110 to add and remove food items 150F from the digital food inventory 150E, generate scannable codes to be printed using the printer 130, and view recipes 150H stored in the recipe catalog 150G, but may not be able to access or modify freezer details 150B or compliance records. In one or more embodiments, a third user may be a guest user with public link access to the food inventory management application 110, which third user may only be able to remove a food item 150F from the digital food inventory 150E by scanning a scannable code associated with the food item 150F. In one or more embodiments, a fourth user may be a regulatory officer, which fourth user may have read-only permissions to access certification records associated with a food item 150F by scanning a scannable code associated with the food item 150F. In one or more embodiments, a fifth user may be a food bank partner, which fifth user may only have access to a donation inventory of the digital food inventory 150E and to compliance records associated with the certification parameters 150K. In one or more embodiments, the owner or administrator of the user account associated with the food inventory management application 110 may invite, via a sharable link, additional users to access the user account.

In one or more embodiments, the food storage cabinet 105 associated with the food inventory management application 110 may be a freezer for freezing and storing frozen food items 150F. In one or more embodiments, the food storage cabinet 105 may have a plurality of shelves, bins, drawers, compartments, or zones for storing the food items 150F. In one or more embodiments, the food storage cabinet 105 may be configurable to a specific climate, temperature, or range of temperatures. In one or more embodiments, each individual shelf, bin, drawer, compartment, or zone may be individually configurable to a specific climate, temperature, or range of temperatures.

In one or more embodiments, a digital food storage cabinet associated with the food storage cabinet 105 may be created using and within the food inventory management application 110. In one or more embodiments, the digital food storage cabinet may be configured with as many shelves, bins, drawers, compartments, or zones as the food storage cabinet 105 and with as same climates, temperatures, or range of temperatures so that the digital food storage cabinet is an accurate representation of the food storage cabinet 105 to facilitate accurate inventorying and management of food items 150F stored in the food storage cabinet 105. In one or more embodiments, such freezer details 150B associated with the food storage cabinet 105 and defining the digital food storage cabinet may be entered and communicated to the food inventory management application 110 via the GUI 155 of the user device 115. In one or more embodiments, a user may create one or more digital food storage cabinets associated with one or more food storage cabinets 105 within the food inventory management application 110.

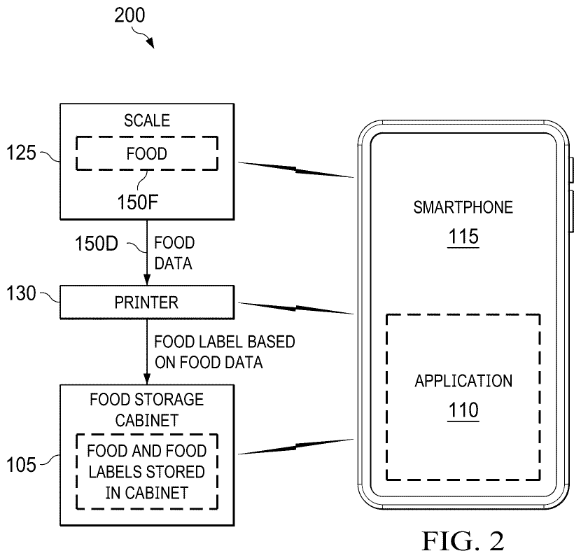

FIG. 2 illustrates an example data flow 200 associated with operation of the food inventory management system 100, according to one or more embodiments. In one or more embodiments, a user of the food inventory management application 110 may desire to add a food item 150F to the food storage cabinet 105 and add the food item 150F to the digital food inventory 150E via the food inventory management application 110. To do so, in one or more embodiments, the user may input a plurality of food details 150D associated with the food item 150F using the food inventory management application 110 and using the input device 160 of the GUI 155 of the user device 115. In one or more embodiments, the food details 150D associated with the food item 150F may include a food type, a food cut, a food weight, a food storage date, a food storage location within the food storage cabinet 105 (e.g., top shelf-left bin), a food source, a food processing date, a food processing method, a food packaging type, an expected shelf life or expiration date, or other related information as desired for a particular application.

In one or more embodiments, the food inventory management application 110 is in communication with the food storage cabinet 105 and designates, identifies, or assigns the food storage location for the food item 150F. In one or more embodiments, the designation of the food storage location may be made manually by the user via the food inventory management application 110 and/or via the food storage cabinet 105. Regardless, in some embodiments, the designation is printed on a food label to facilitate positioning of the food item 150F is the designated food location within the food storage cabinet 105.

In one or more embodiments, the food weight associated with the food item 150F may be entered manually. In one or more embodiments, the food item 150F may be placed on the scale 125, which scale 125 may weigh the food item 150F and wirelessly transmit or communicate the food weight associated with the food item 150F to the food inventory management application 110 via the network 135.

In one or more embodiments, the plurality of food details 150D may be used to create or establish the digital record 150C associated with the food item 150F. In one or more embodiments, upon creation of the digital record 150C associated with the food item 150F, the food item 150F may then be added to the digital food inventory 150E.

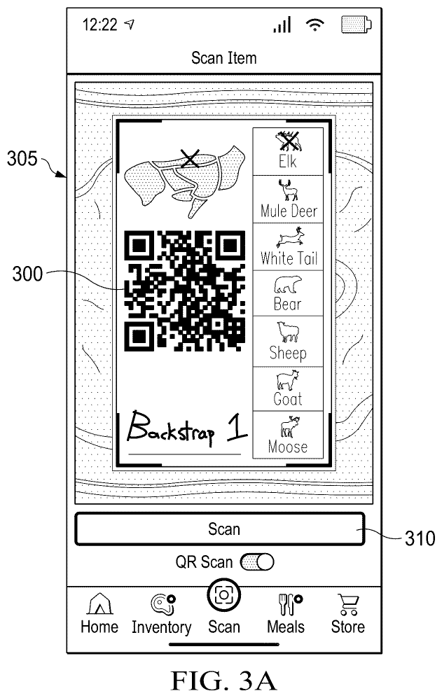

In one or more embodiments, using the plurality of food details 150D associated with the food item 150F, the food inventory management program 110 may create or generate a scannable code associated with, or including, the plurality of food details 150D associated with the food item 150F (as shown in FIGS. 3A and 3B). In one or more embodiments, the scannable code may be a quick-response (“QR”) code. In one or more embodiments, the scannable code is a 2-D code, but it may also be a linear barcode or combination of both. The scannable code may include a PDF-417 code, a data matrix, an Aztec code, a Maxicode, etc. In one or more embodiments, the food inventory management application 110 and the user device 115 may be configured to wirelessly transmit or communicate the scannable code to the printer 130 for printing via the network 135. In one or more embodiments, the printer 130 may be a label printer configured to print the scannable code onto a label or sticker. In one or more embodiments, the scannable code, once printed using printer 130, may be configured to be attached or affixed to the food item 150F with which it is associated. In one or more embodiments, upon creation of the scannable code associated with the food item 150F, the scannable code may be scanned to add the food item 150F to the digital food inventory 150E. In one or more embodiments, the food item 150F may then be stored in the food storage cabinet 105 with the scannable code affixed to the food item 150F. By affixing the scannable code to the food item 150F, a user of the food inventory management program 110 may simply scan the scannable code using the user device 115 to quickly retrieve or display the food details 150D associated with the food item 150F.

FIG. 3A illustrates a scannable code 300 affixed to a food item 150F, according to one or more embodiments. FIG. 3A also illustrates a scan section 305 associated with the food inventory management application 110 displayed via the GUI 155 of the user device 115, the scan section 305 including a scan feature 310. In one or more embodiments, as shown in FIG. 3A, using the user device 115 and the food inventory management program 110, the scannable code 300 may be scanned using the scan feature 310 to retrieve the food details 150D associated with the food item 150F on which the scannable code 300 is affixed. In one or more embodiments, the scannable code 300 may be scanned directly using a camera associated with the user device 115 without first accessing the food inventory management application 110; however, upon scanning the scannable code 300, the food inventory management application 110 may be automatically opened and accessed, or the user may be directed to a webpage such that downloading of the food inventory management application 110 is not required.

As shown in FIG. 3A, in one or more embodiments, the scannable code 300 is placed in view of the camera and the food inventory management application 110 reads, upon the selection of the selectable scan feature 310, the scannable code 300, which represents the food details 150D associated with the food item 150F. However, in other embodiments, the selection of the scan feature 310 is not necessary and the food inventory management application 110 recognizes the scannable code 300 upon the scannable code 300 being placed in the view of the camera.

In one or more embodiments, the scannable code 300 is printed on a label including information or data in addition to the scannable code 300. In one or more embodiments, the food inventory management application 110 is configured to read such additional data from the label that is separate from the scannable code 300. For example, the food inventory management application 110 may detect a selection (illustrated in FIG. 3A with an “X”) of the food type (e.g., elk, Mule deer, Whitetail, Bear, Sheep, Goat, Moose) and the food cut (e.g., backstrap, shoulder, neck, shank, flank, rump). However, as discussed above, this additional data may also be included in the scannable code 300.

In one or more embodiments, the scannable code 300 may also be scanned in order to remove the food item 150F from the digital food inventory 150E. For example, in one or more embodiments, a user may desire to remove and consume the food item 150F from the food storage cabinet 105, and to do so may remove the food item 150F from the food storage cabinet 105, scan the scannable code 300 using the user device 115 and scan feature 305 of the food inventory management application 110, and make a selection to remove the food item 150F from the digital food inventory 150E.

FIG. 3B illustrates another embodiment of the scannable code 300. In the embodiments shown in FIGS. 3A and 3B, the food item 150F associated with the scannable code 300 is an elk backstrap steak.

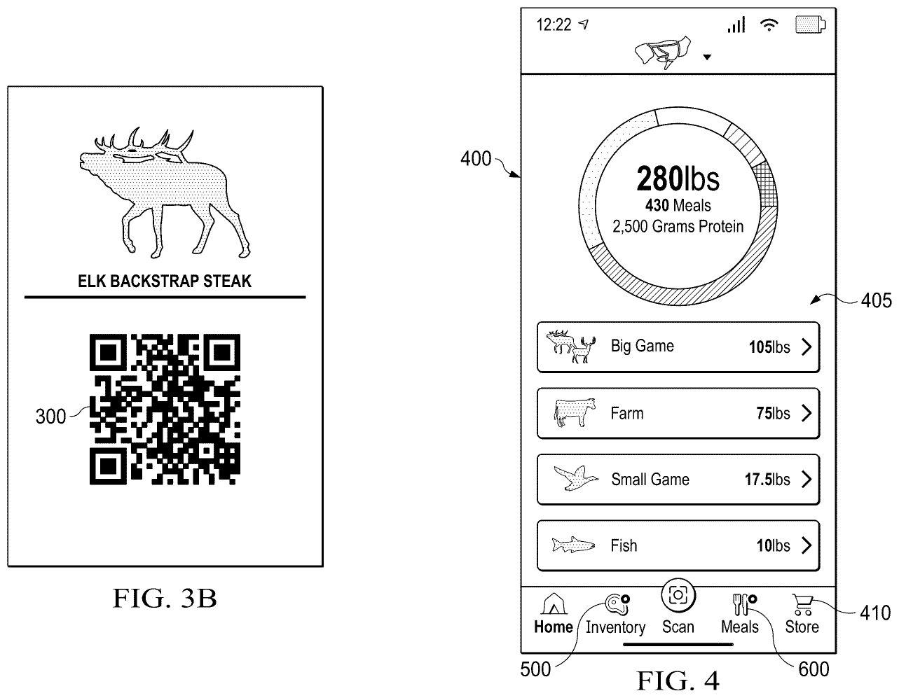

FIG. 4 illustrates a home section 400 associated with the food inventory management application 110. As shown, the home section 400 may display a summary 405 or overview of the digital food inventory 150E. In one or more embodiments, the summary 405 of the digital food inventory 150E includes a total weight of the plurality of food items 105F in the digital food inventory 150E and in the food storage cabinet 105, an estimated total number of meals that may be prepared using the plurality of food items 150F in the digital food inventory 150E and in the food storage cabinet 105, an estimated total amount of protein associated with the plurality of food items 150F in the digital food inventory 150E and in the food storage cabinet 105, or a selectable categorization of the plurality of food items 150F in the digital food inventory 150E and in the food storage cabinet 105. In one or more embodiments, the categories may include, for example, big game, farm, small game, and fish.

A further illustrated in FIG. 4, the food inventory management application 110 includes selectable links associated with additional sections of the food inventory management application 110, including the home section 400, an inventory section 500, a meals section 600, and a store section 410. In one or more embodiments, the store section 410 may include links to prep supplies, knives, labels, bags, and other related items that may be purchased through the food inventory management application 110.

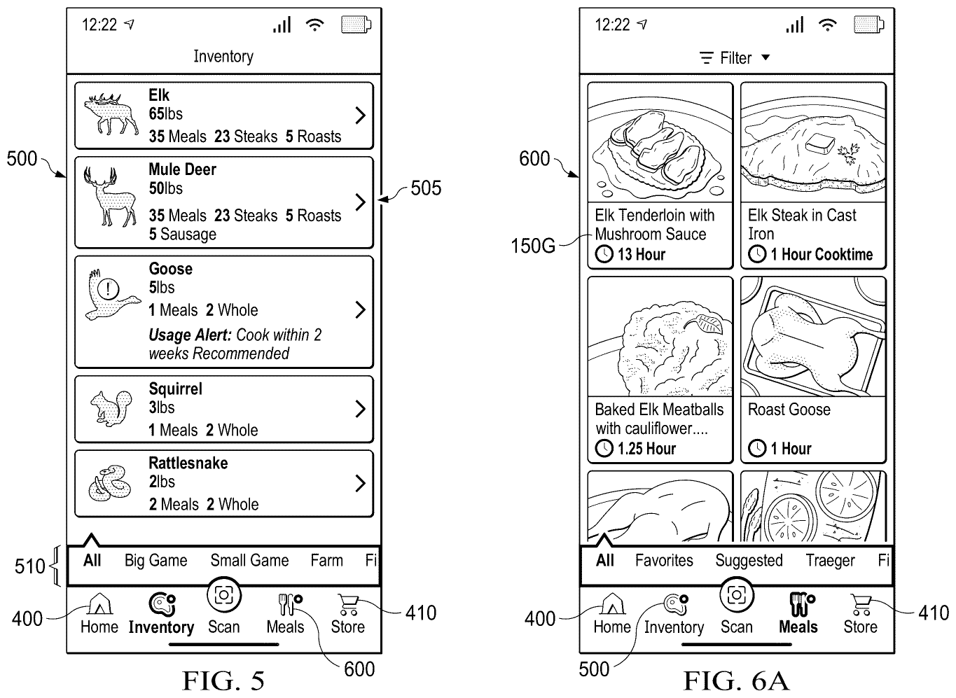

FIG. 5 illustrates an inventory section 500 associated with the food inventory management application 110. In one or more embodiments, the inventory section 500 displays information associated with the digital food inventory 150E, including the plurality of food items 150F, and the digital record 150C, including the plurality of food details 150D associated with the plurality of food items 150F. In one or more embodiments, the information associated with the digital food inventory 150E and the digital record 150C may be updated and displayed in real-time such that an accurate representation of the available food items 150F is displayed to a user. In the embodiment shown, a landing page associated with the inventory section 500 displays a summary 505 of the plurality of food items 150F in the digital food inventory 150E categorized by one of the plurality of food details 150D. In the embodiment shown, the summary 505 of the plurality of food items 150F in the digital food inventory 150E is categorized by food type, such as, for example, the type of animal. In one or more embodiments, a summary associated with each category may also be shown and include a total weight of each food type, a total estimated number of meals that can be prepared with each food type, and totals of each type of food cut associated with each food type. For example, as shown in FIG. 5, the first category is elk, and the summary associated with elk indicates that there is a total of 65 lbs of elk, which includes 23 steaks and 5 roasts, and which can make an estimated 35 meals. In one or more embodiments, each category displayed on the landing page of the inventory section may be selectable, such that when a category is selected, additional details associated with that category may be displayed.

In one or more embodiments, the landing page of the inventory section 500 may also include a list of selectable filters 510 that may be selected to show, for example, all food types, big game, small game, farm, fish, or other categories.

In one or more embodiments, the food inventory management application 110 may also include a search feature that enables a user to search within the digital food inventory 150E. In one or more embodiments, the search feature may enable a user to search the digital food inventory 150E using any one or more of the food details 150D as a search criteria, including food type, food cut, food storage date, food storage location, and expected shelf life or estimated expiration date.

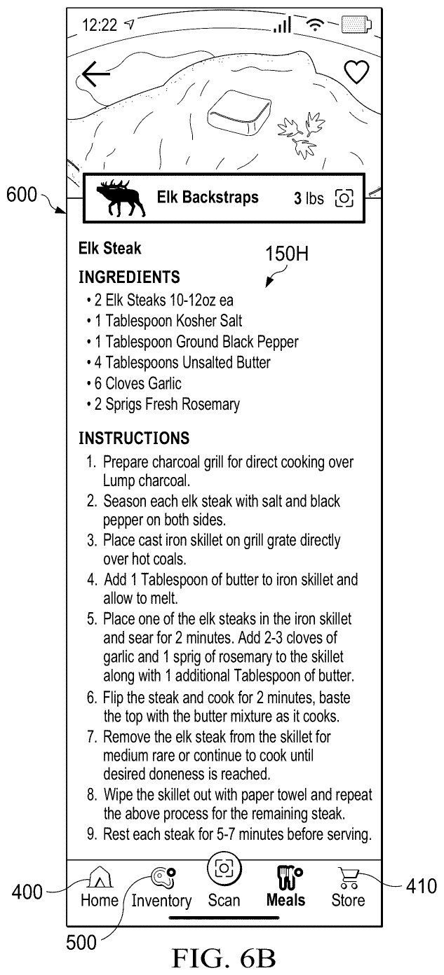

FIG. 6A illustrates a meal section 600 associated with the food inventory management application 110. In the embodiment shown, the meal section 600 displays a plurality of recipes 150H of a recipe catalog 150G associated with the plurality of food items 150F of the digital food inventory 150E. In one or more embodiments, at least one recipe 150H is generated for each food item 150F in the digital food inventory 150E, or for each category (e.g., categorized by food details 150D, such as food type) of food item 150F in the digital food inventory 150E. In one or more embodiments, each of the plurality of recipes 150H displayed in the meal section 600 is selectable such that, upon selection, additional details, including ingredients and instructions, associated with the selected recipe 150H are displayed (see FIG. 6B). In one or more embodiments, the meal section 600 may include a list of selectable filters 605 for filtering the plurality of recipes 150H displayed in the meal section, which list of selectable filters 605 may include all recipes, favorite recipes, suggested recipes, Traeger recipes, recipes by animal type, or other similar filters.

In one or more embodiments, the plurality of recipes 150H may be accessed and retrieved via the Internet. In one or more embodiments, the plurality of recipes 150H may be stored in, and accessed and retrieved from, the database 150.

In one or more embodiments, a user may input dietary restrictions or preferences into the food inventory management application 110. In one or more embodiments, food inventory management application 110 may automatically and dynamically adjust the plurality of recipes 150H displayed in the meal section 600 based on the provided dietary restrictions or preferences. In one or more embodiments, food inventory management application 110 may automatically and dynamically adjust the plurality of recipes 150H displayed in the meal section 600 in real-time or near real-time based on an inventory level of the digital food inventory 150E.

FIG. 6B illustrates the meal section 600 after a selection of one of the plurality of recipes 150H has been received, according to one or more embodiments. As shown, once a selection of one of the plurality of recipes 150H has been made, additional details, including ingredients and instructions needed to prepare the selected recipe 150H, are displayed via the GUI 155.

In one or more embodiments, the food inventory management application 110 is configured to track or monitor consumption patterns and consumption rates associated with a user's consumption of the food items 150F in the digital food inventory 150E and the food storage cabinet 105. In one or more embodiments, consumption data 1501 associated with the tracked consumption patterns and consumption rates is stored in the database 150. In one or more embodiments, the tracked or monitored consumption patterns and consumption rates may be associated with or categorized by any one or more of the food details 150D. For example, in one or more embodiments, the food inventory management application 110 may track or monitor how frequently a user removes a specific food type or food cut from the digital food inventory 150E and from the food storage cabinet 105 and how much (e.g., weight) of such food type or food cut the user removes at a time. In one or more embodiments, the food inventory management application 110 may be configured to recommend recipes 150H based on the consumption data 1501, such as, for example, to recommend favorite recipes or to recommend recipes for food items that are consumed less frequently.

In one or more embodiments, the food inventory management application 110 is configured to track or monitor expiration information 150J associated with the plurality of food items 150F in the digital food inventory 150E and in the food storage cabinet 105. In one or more embodiments, expiration information 150J may be accessed or retrieved from the Internet or provided by a user in the food detail 150D and stored in the database 150. In one or more embodiments, the expiration information 150J may include information related to the length of time a particular food item 150F can stay in the food storage cabinet 105, based on the freezer details 150B (e.g., the climate of the food storage cabinet 105), before that particular food item 150F will expire or spoil. In one or more embodiments, such expiration information 150J may be based on laws, rules, or regulations concerning health and safety standards for food.

In one or more embodiments, the food inventory management application 110 is configured to generate alerts based on the data stored in the database 150, including the user information 150A, the freezer details 150B, the digital records 150C including the food details 150D, the digital food inventory 150E including the food items 150F, the recipe catalog 150G including the recipes 150H, the consumption data 1501, and the expiration information 150J. In one or more embodiments, the alert may include a meal recommendation or an expiration warning.

In one or more embodiments, the food inventory management application 110 is configured to learn behaviors associated with a user of the food inventory management application 110 to predict future use or consumption of food items 150F in the digital food inventory 150E such that more relevant meal ideas and recipes 150H can be recommended via alerts, and to provide alerts relating to the removal of specific food items 150F from the food storage cabinet 105 before those food items 150F expire or spoil.

In one or more embodiments, the food inventory management application 110 uses location services associated with the user device 115 and an associated user to determine when and how to push and display alerts to the user via the user device 115. For example, in one or more embodiments, the food inventory management application 110 may determine that a user associated with the user device 115 leaves his or her home (e.g., where the food storage cabinet 105 is located) on most weekdays at 9 am for 8 hours. Using this determination, the food inventory management application 110 may push or display an alert via the user device 115 at 8:30 am associated with a meal idea or a recommendation to remove a specific food item 150F from the food storage cabinet 105 to ensure that the food item 150F is ready to be prepared for a meal that evening.

In one or more embodiments, the food inventory management application 110 is configured to monitor the digital food inventory 150E and generate an alert when a particular food item 150F in the digital food inventory 150E is within a predetermined period of time of a predicted expiration date associated with that particular food item 150F. In one or more embodiments, based on the food details 150D, the freezer details 150B, the consumption data, and the expiration information 150J, the food inventory management application 110 may determine that certain food items 150F will expire before they are consumed, and thus a usage or expiration alert for such food items 150F can be generated. For example, the food inventory management application 110 is configured to determine and alert a user when, based on the relevant data described above, 35 lbs of food will remain unused at the time of its expiration.

In some embodiments, the food inventory management application 110 is in communication with, or integrates, a software with predictive capabilities, such as those described above. In one or more embodiments, the software with predictive capabilities may include artificial intelligence (“AI”), generative AI, machine learning, deep learning, etc. In one or more embodiments, in addition to the predictive capabilities described above, the food inventory management application 110 may be configured to recognize food details 150D as they are being input via the GUI 155 so that additional related food details 150D can be auto populated or suggested to make creation of the digital records 150C more efficient.

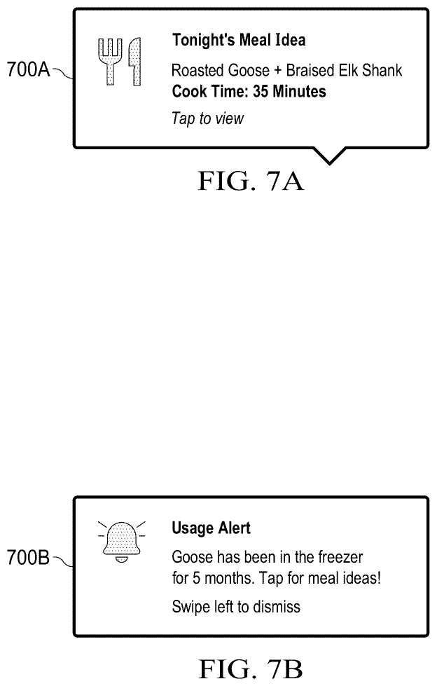

FIG. 7A illustrates a meal idea alert 700A associated with a meal idea, according to one or more embodiments. In one or more embodiments, the meal idea alert 700A is associated with a food item 150F in the digital food inventory 150E and one or more recipes 150H that are associated with the food item 150F. In one or more embodiments, the food inventory management application 110 may push the meal idea alert 700A to the user device 115 and display the meal idea alert 700A via the GUI 155. In one or more embodiments, the meal idea alert 700A may be selectable such that upon selection of the meal idea alert 700A, additional details associated with the food item 150F and the recipe 150H may be displayed.

FIG. 7B illustrates a usage alert 700B associated with a usage warning or an expiration warning, according to one or more embodiments. In one or more embodiments, the usage alert 700B is associated with a food item 150F in the digital food inventory 150E that has been stored in the food storage cabinet 105 for a certain period of time or that may be expiring soon. In one or more embodiments, the food inventory management application 110 may push the usage alert 700B to the user device 115 and display the usage alert 700B via the GUI 155. In one or more embodiments, the usage alert 700B may be selectable such that upon selection of the usage alert 700B, one or more recipes 150H associated with the food item 150F may be displayed.

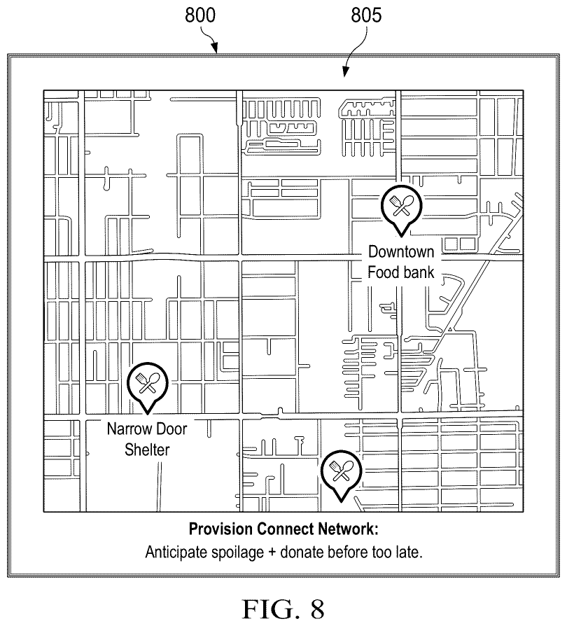

FIG. 8 illustrates a map 800 including a provision connection network 805, according to one or more embodiments. In one or more embodiments, the provision connection network 805 is a platform associated with or included within the food inventory management application 110. The provision connection network 805 is configured to allow users of the food inventory management application 110 to connect, share, trade, sell, or donate food items 150F in their respective food storage cabinets 105. In one or more embodiments, the provision connection network 805 may include shelters and food banks looking to receive donations of food items 150F. In one or more embodiments, the provision connection network 805 is configured to identify potential donors and connect the potential donors with potential recipients, including shelters, food banks, and neighbors.

With continued reference to FIGS. 1, 2, 3A, 3B, 4-5, 6A, 6B, 7A, and 7B, in one or more embodiments, the food inventory management system 100 is also configured to facilitate food certification and compliance tracking. In one or more embodiments, the food inventory management application 110 includes a food certification and compliance portion that enables a user to log food certification and compliance details and enable a user to certify a food item.

In general, the food certification and compliance portion of the food inventory management application 110 is configured to be used by hunters. When a hunter kills an animal, it is desirable to be able to log details associated with how the animal was killed, where the animal was killed, when the animal was killed, the temperature of the environment in which the animal was killed, the temperature of the environment in which the animal was initially stored, the temperature of the environment in which the animal was stored in long-term storage, the amount of time the animal was stored in long-term storage, the number of animals that were killed, and other related details that would be desirable or required for legal and regulatory certification and compliance purposes.

In one or more embodiments, the food certification and compliance portion enables a hunter to log certification details associated with the handling of the animal from the time the animal was killed to the time the animal was stored and distributed. In one or more embodiments, the food details 150D may include the certification details. In one or more embodiments, the certification details may be logged separately from the food details 150D, but the digital record 150C associated with the food item 150F may also include the certification details. For clarity purposes, food item 150F will be used to refer to the animal and the meat obtained from the animal when describing the food certification and compliance portion.

In one or more embodiments, when a food item 150F (e.g., an animal) is killed out in nature, a user may access the food certification and compliance portion of the food inventory management application 110 to input or log certification details associated with the circumstances surrounding the killing and processing of the food item 150F. In one or more embodiments, the food inventory management application 110 may allow the user to manually input food certification details including a date the food item 150F was killed, a time the food item 150F was killed, a location in which the food item 150F was killed, a method in which the animal was killed (e.g., bow or rifle), a temperature associated with the natural environment in which the food item 150F was killed, and a temperature associated with the storage environment in which the food item 150F was initially stored in the natural environment or during transportation (e.g., field dressing, cooler storage, ice chest). In one or more embodiments, the food certification details associated with the food item 150F may be including in the food details 150D associated with the food item 150F. In one or more embodiments, the food certification details associated with the food item 150F may be included in the digital food record 150C associated with the food item 150F, but may be separate from the food details 150D.

In one or more embodiments, the food certification and compliance portion of the food inventory management application 110 may automatically log one or more food compliance details associated with the food item 150F. For example, in one or more embodiments, when a user kills the food item 150F, the user may take a picture of the food item 150F using the camera associated with user device 115, which may be accessed via the food inventory management application 110. When the user takes the picture of the food item 150F, metadata associated with the picture may include one or more food certification details that may be automatically accessed and logged in the food inventory management application 110. In one or more embodiments, the metadata associated with the picture may include a time, a date, a location, and a temperature when the picture was taken. This information may be automatically accessed and retrieved from the picture by the food inventory management application 110 and logged as food certification details associated with the food item 150F. In one or more embodiments, using the machine learning model 170, the food inventory management application 110 may be able to retrieve food details 150D from the picture, including food type, via image recognition.

In one or more embodiments, exchange image file format (EXIF) standards may be used to store the metadata within the picture, which is a digital picture or image. In one or more embodiments, global positioning system (“GPS”) sensors associated with the user device may be accessed or used to automatically record GPS, including latitude and longitude, coordinates associated with the picture, which GPS coordinates may then be embedded within the picture as EXIF data, or metadata. In one or more embodiments, other portions of the user device 115 may be accessed such that the date, time, and temperature associated with the picture may also be embedded within the picture as EXIF data. In one or more embodiments, the food inventory management application 110 may automatically access, retrieve, and log such EXIF data as certification details associated with the food item 150F, which is associated with the picture.

In one or more embodiments, additional certification details that may be logged by the user via the food inventory management application 110 may include the how the food item 150F was butchered, when the food item 150F was butchered, how the food item 150F was packaged, a temperature associated with the storage environment in which the food item 150F was finally stored in the food storage cabinet 105. As discussed above, these food certification details may be used to establish and create the digital record 150C associated with the food item 150F.

In one or more embodiments, the food certification details, the food details 150D, or the food record 150C associated with the food item 150F are compared to certification parameters 150K, which may be stored in the database 150. In one or more embodiments, the certification parameters 150K may be associated with food item health and safety laws and regulations or hunting laws and regulations including, for example, bag limits. In one or more embodiments, if the food certification details, the food details 150D, or the food record 150C associated with the food item 150F satisfy the certification parameters 150K, the food item 150F may be certified.

In one or more embodiments, if the food item 150F is certified, the food inventory management application 110 may generate a scannable certification code, or a certification badge, that is associated with, or includes, the food certification details, the food details 150D, or the food record 150C. In one or more embodiments, the scannable certification code may be separate from, but include the same components as, the scannable code 300 such that the scannable certification code may also be affixed to the food item 150F. In one or more embodiments, the scannable code 300 may be or include the scannable certification code, or include the information and details associated with the scannable certification code.

In one or more embodiments, the scannable certification code may be affixed to the food item 150F such that law enforcement, fish and game wardens and officers, or other relevant authorities may scan the scannable certification code and access the food certification details or the certification badge to instantly verify the status of the food item 150F as certified, and to instantly verify compliance with other relevant law, rules, regulations, or ethical hunting practices. In one or more embodiments, for example, scanning the scannable certification code may display bag limit compliance.

In one or more embodiments, the provision connection network 805 may only allow and include food items 150F that have been certified as described above. In one or more embodiments, the provision connection network 805 may allow users to donate certified food items 150F to food banks that participate in the provision connection network 805. In one or more embodiments, the food inventory management application 110 may be configured to generate donation receipts for tax purposes when a user donates a food item 150F via the provision connection network 805.

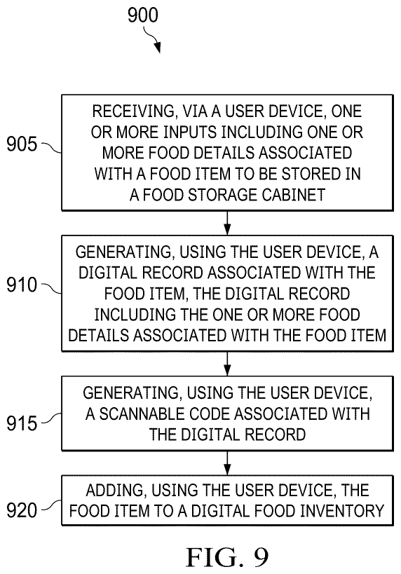

FIG. 9 illustrates a method 900 of operating the food inventory management system 100, according to one or more embodiments.

At step 905, the method 900 includes receiving, via a user device, one or more inputs including one or more food details associated with a food item to be stored in a food storage cabinet. In one or more embodiments, the user device may be user device 115. In one or more embodiments, the one or more inputs may be received via the GUI 155 of the user device 115. In one or more embodiments, the food details may be food details 150D. In one or more embodiments, the food storage cabinet may be food storage cabinet 105.

At step 910, the method 900 includes generating, using the user device, a digital record associated with the food item, the digital record including the one or more food details associated with the food item. In one or more embodiments, the digital record may be digital record 150C.

At step 915, the method 900 includes generating, using the user device, a scannable code associated with the digital food record. In one or more embodiments, the scannable code may be scannable code 300.

At step 920, the method 900 includes adding, using the user device, the food item to a digital food inventory. In one or more embodiments, the digital food inventory may be digital food inventory 150E.

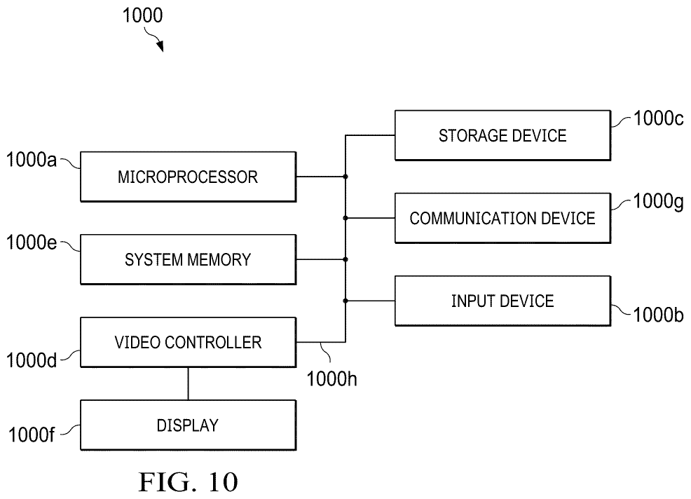

FIG. 10 illustrates a node 1000 for implementing one or more of the example embodiments described above, and/or any combination thereof.

The node 1000 includes a microprocessor 1000a, an input device 1000b, a storage device 1000c, a video controller 1000d, a system memory 1000e, a display 1000f, and a communication device 1000g all interconnected by one or more buses 1000h. In several example embodiments, the storage device 1000c may include a hard drive, CD-ROM, optical drive, any other form of storage device and/or any combination thereof. In several example embodiments, the storage device 1000c may include, and/or be capable of receiving, CD-ROM, DVD-ROM, or any other form of computer-readable medium that may contain executable instructions. In several example embodiments, the communication device 1000g may include a modem, network card, or any other device to enable the node to communicate with other nodes. In several example embodiments, any node represents a plurality of interconnected (whether by intranet or Internet) computer systems, including without limitation, personal computers, mainframes, PDAs, smartphones, and cell phones.

In several example embodiments, one or more of the components of the systems described above, and/or any combination thereof, include at least the node 1000 and/or components thereof, and/or one or more nodes that are substantially similar to the node 1000 and/or components thereof. In several example embodiments, one or more of the above-described components of the node 1000 and/or the system 100 include respective pluralities of same components.

In several example embodiments, one or more of the applications, systems, and application programs described above, and/or any combination thereof, include a computer program that includes a plurality of instructions, data, and/or any combination thereof; an application written in, for example, Arena, Hypertext Markup Language (HTML), Cascading Style Sheets (CSS), JavaScript, Extensible Markup Language (XML), asynchronous JavaScript and XML (Ajax), and/or any combination thereof; a web-based application written in, for example, Java or Adobe Flex, which in several example embodiments pulls real-time information from one or more servers, automatically refreshing with latest information at a predetermined time increment; or any combination thereof.

In several example embodiments, a computer system typically includes at least hardware capable of executing machine readable instructions, as well as the software for executing acts (typically machine-readable instructions) that produce a desired result. In several example embodiments, a computer system may include hybrids of hardware and software, as well as computer sub-systems.

In several example embodiments, hardware generally includes at least processor-capable platforms, such as client-machines (also known as personal computers or servers), and hand-held processing devices (such as smart phones, tablet computers, personal digital assistants (PDAs), or personal computing devices (PCDs), for example). In several example embodiments, hardware may include any physical device that can store machine-readable instructions, such as memory or other data storage devices. In several example embodiments, other forms of hardware include hardware sub-systems, including transfer devices such as modems, modem cards, ports, and port cards, for example.

In several example embodiments, software includes any machine code stored in any memory medium, such as RAM or ROM, and machine code stored on other devices (such as flash memory, or a CD ROM, for example). In several example embodiments, software may include source or object code. In several example embodiments, software encompasses any set of instructions capable of being executed on a node such as, for example, on a client machine or server.

In several example embodiments, combinations of software and hardware could also be used for providing enhanced functionality and performance for certain embodiments of the present disclosure. In an example embodiment, software functions may be directly manufactured into a silicon chip. Accordingly, it should be understood that combinations of hardware and software are also included within the definition of a computer system and are thus envisioned by the present disclosure as possible equivalent structures and equivalent methods.

In several example embodiments, computer readable mediums include, for example, passive data storage, such as a random-access memory (RAM) as well as semi-permanent data storage such as a compact disk read only memory (CD-ROM). One or more example embodiments of the present disclosure may be embodied in the RAM of a computer to transform a standard computer into a new specific computing machine. In several example embodiments, data structures are defined organizations of data that may enable an embodiment of the present disclosure. In an example embodiment, a data structure may provide an organization of data, or an organization of executable code.

In several example embodiments, any networks and/or one or more portions thereof may be designed to work on any specific architecture. In an example embodiment, one or more portions of any networks may be executed on a single computer, local area networks, client-server networks, wide area networks, internets, hand-held and other portable and wireless devices, and networks.

In several example embodiments, a database may be any standard or proprietary database software. In several example embodiments, the database may have fields, records, data, and other database elements that may be associated through database specific software. In several example embodiments, data may be mapped. In several example embodiments, mapping is the process of associating one data entry with another data entry. In an example embodiment, the data contained in the location of a character file can be mapped to a field in a second table. In several example embodiments, the physical location of the database is not limiting, and the database may be distributed. In an example embodiment, the database may exist remotely from the server, and run on a separate platform. In an example embodiment, the database may be accessible across the Internet. In several example embodiments, more than one database may be implemented.

In several example embodiments, a plurality of instructions stored on a computer readable medium may be executed by one or more processors to cause the one or more processors to carry out or implement in whole or in part the above-described operation of each of the above-described example embodiments of the system, the method, and/or any combination thereof. In several example embodiments, such a processor may include one or more of the microprocessor 1000a, any processor(s) that are part of the components of the system, and/or any combination thereof, and such a computer readable medium may be distributed among one or more components of the system. In several example embodiments, such a processor may execute the plurality of instructions in connection with a virtual computer system. In several example embodiments, such a plurality of instructions may communicate directly with the one or more processors, and/or may interact with one or more operating systems, middleware, firmware, other applications, and/or any combination thereof, to cause the one or more processors to execute the instructions.

The present disclosure provides a food inventory management application designed for, among others, hunters, homesteaders, and meat enthusiasts to efficiently store, organize, and track their meat inventory across multiple freezers. In one or more embodiments, the food inventory management application integrates with Bluetooth scales and label printers to automate weight capture and labeling, while also tracking expiration, consumption patterns, and meal utilization. In one or more embodiments, the food inventory management application also includes a certification system, which allows hunters to log kill dates, storage conditions, and compliance with bag limits to simplify legal compliance, enable food donations to food banks, and provide proof of ethical hunting practices.

In one or more embodiments, the food inventory management application: enable users to sign up and sign in securely; allow users to configure their freezers and manage inventory; provides a seamless process for adding cuts of meat, defining storage locations, and tagging items with QR-coded labels; integrates with Bluetooth scales and label printers to streamline weight capture and metadata tagging; maintains an accurate inventory of all stored meat, tracking expiration dates, consumption patterns, and meal projections; suggests recipes based on available meat to reduce food waste; enable users to scan QR codes with a standard phone camera to remove items from inventory, even without app access; provides a certification process that tracks when an animal was killed, how it was stored, and the temperature it was kept at; generate certification labels that help hunters comply with legal bag limits; and allows hunters to donate certified meat to food banks, integrating with food bank networks for streamlined donations.

The present disclosure provides a method for food inventory management, comprising: receiving, via a food inventory management application, one or more inputs including one or more food details associated with a food item to be stored in a food storage cabinet; generating, using the food inventory management application, a digital record associated with the food item; wherein the digital record includes the one or more food details associated with the food item; generating, using the food inventory management application, a scannable code associated with the digital record, wherein the scannable code is configured to be affixed to the food item; and adding, using the food inventory management application, the food item to a digital food inventory corresponding to a physical food inventory associated with the food storage cabinet. In some embodiments, the one or more food details include at least one of a food type, a food cut, a food weight, a food storage date, and a food storage location. In some embodiments, the method also includes: accessing, by the food inventory management application, certification parameters; comparing at least one of the one or more food details with the certification parameters; and determining, based on the comparison, that the food item is certified. In some embodiments, a first input of the one or more inputs is received from a user of the food inventory management application and includes a first food detail of the one or more food details; wherein the first food detail includes a food type, a food cut, a food storage date, or a food storage location; wherein a second input of the one or more inputs is received from a food scale in communication with the food inventory management application and includes a second food detail of the one or more food details; and wherein the second food detail includes a food weight. In some embodiments, the scannable code is configured to be scanned by a camera. In some embodiments, the method also includes: transmitting, using the food inventory management application, the scannable code to a printer; wherein the scannable code is configured to be printed by the printer. In some embodiments, the method also includes: generating, using the food inventory management application, a notification associated with the food item; and displaying, via a graphical user interface, the notification associated with the food item. In some embodiments, the notification includes a meal idea associated with the food item. In some embodiments, the notification includes an expiration warning associated with the food item. In some embodiments, the notification is generated based on consumption data associated with a rate at which food items are removed from the digital food inventory. In some embodiments, the method also includes: scanning, using the food inventory management application, the scannable code to retrieve the one or more food details associated with the food item from the digital record; receiving, by the food inventory management application, a request to remove the food item from the digital food inventory; and removing, using the food inventory management application, the food item from the digital food inventory.

The present disclosure also introduces a method for food inventory management, comprising: generating a food inventory including a plurality of food items and a plurality of food details associated with each respective food item, wherein the food details associated with each respective food item include an anticipated expiration date of the respective food item; generating a recipe catalog including recipes associated with the plurality of food items in the food inventory; collecting consumption data associated with a rate at which food items are removed from the food inventory; identifying, based on the consumption data and the anticipated expiration dates, that a food item of the plurality of food items in the food inventory is an expiring food item that will expire prior to being removed from the food inventory; and generating, based on the identification of the expiring food item, a notification including the anticipated expiration date of the expiring food item and a recipe of the recipe catalog associated with the expiring food item. In some embodiments, the plurality of food items are stored in a food storage cabinet. In some embodiments, the method also includes monitoring internal conditions of the food storage cabinet in which the plurality of food items are stored; wherein identifying that the food item of the plurality of food items is the expiring food item is further based on the internal conditions of the food storage cabinet. In some embodiments, the food details include a food storage location associated with a location of the respective food item within the food storage cabinet. In some embodiments, the method also includes accessing food safety information associated with safe storage durations for each of the plurality of food items in the food inventory; wherein each anticipated expiration date is based on the food safety information.

The present disclosure also discloses a food inventory management system, comprising: a food storage cabinet; a printer in wireless communication with one or more processors; a scale in wireless communication with the one or more processors; and a non-transitory computer readable medium having stored thereon a plurality of instructions, wherein the instructions are executed with the one or more processors so that the following steps are executed: receiving a first input including a first food detail associated with a food item to be stored in the food storage cabinet, wherein the first food detail includes a food storage date; receiving, from the scale, a second input including a second food detail associated with the food item to be stored in a food storage cabinet, wherein the second food detail includes a food weight; generating a scannable code associated with the first and second food details and the food item; transmitting the scannable code to the printer, wherein the scannable code is configured to be printed by the printer and subsequently affixed to the food item associated with the scannable code; adding the food item to a food inventory; scanning the scannable code to display the food details associated with the food item; and removing the food item from the food inventory. In some embodiments, the instructions are executed with the one or more processors so that the following additional steps are executed: generating a notification associated with the food item; and displaying the notification associated with the food item. In some embodiments, the notification includes a meal idea associated with the food item. In some embodiments, the notification is generated based on the food storage date associated with the food item; and wherein the notification includes an expiration warning associated with the food item.

In several example embodiments, the elements and teachings of the various illustrative example embodiments may be combined in whole or in part in some or all of the illustrative example embodiments. In addition, one or more of the elements and teachings of the various illustrative example embodiments may be omitted, at least in part, and/or combined, at least in part, with one or more of the other elements and teachings of the various illustrative embodiments.

Any spatial references such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several example embodiments, while different steps, processes, and procedures are described as appearing as distinct acts, one or more of the steps, one or more of the processes, and/or one or more of the procedures may also be performed in different orders, simultaneously and/or sequentially. In several example embodiments, the steps, processes and/or procedures may be merged into one or more steps, processes and/or procedures.

In several example embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several example embodiments have been described in detail above, the embodiments described are example only and are not limiting, and those skilled in the art will readily appreciate that many other modifications, changes and/or substitutions are possible in the example embodiments without materially departing from the novel teachings and advantages of the present disclosure. Accordingly, all such modifications, changes and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112(f) for any limitations of any of the claims herein, except for those in which the claim expressly uses the word “means” together with an associated function.

What is claimed is:

1. A method for food inventory management, comprising:
receiving, via a food inventory management application, one or more inputs including one or more food details associated with a food item to be stored in a food storage cabinet;
generating, using the food inventory management application, a digital record associated with the food item;
wherein the digital record includes the one or more food details associated with the food item;
generating, using the food inventory management application, a scannable code associated with the digital record, wherein the scannable code is configured to be affixed to the food item; and
adding, using the food inventory management application, the food item to a digital food inventory corresponding to a physical food inventory associated with the food storage cabinet.

2. The method of claim 1,
wherein the one or more food details include at least one of a food type, a food cut, a food weight, a food storage date, and a food storage location.

3. The method of claim 1, further comprising:
accessing, by the food inventory management application, certification parameters;
comparing at least one of the one or more food details with the certification parameters; and
determining, based on the comparison, that the food item is certified.

4. The method of claim 1,
wherein a first input of the one or more inputs is received from a user of the food inventory management application and includes a first food detail of the one or more food details;
wherein the first food detail includes a food type, a food cut, a food storage date, or a food storage location;
wherein a second input of the one or more inputs is received from a food scale in communication with the food inventory management application and includes a second food detail of the one or more food details; and
wherein the second food detail includes a food weight.

5. The method of claim 1,
wherein the scannable code is configured to be scanned by a camera.

6. The method of claim 1, further comprising:
transmitting, using the food inventory management application, the scannable code to a printer;
wherein the scannable code is configured to be printed by the printer.

7. The method of claim 1, further comprising:
generating, using the food inventory management application, a notification associated with the food item; and
displaying, via a graphical user interface, the notification associated with the food item.

8. The method of claim 7,
wherein the notification includes a meal idea associated with the food item.

9. The method of claim 7,
wherein the notification includes an expiration warning associated with the food item.

10. The method of claim 7,
wherein the notification is generated based on consumption data associated with a rate at which food items are removed from the digital food inventory.

11. The method of claim 1, further comprising:
scanning, using the food inventory management application, the scannable code to retrieve the one or more food details associated with the food item from the digital record;
receiving, by the food inventory management application, a request to remove the food item from the digital food inventory; and
removing, using the food inventory management application, the food item from the digital food inventory.

12. A method for food inventory management, comprising:
generating a food inventory including a plurality of food items and a plurality of food details associated with each respective food item, wherein the food details associated with each respective food item include an anticipated expiration date of the respective food item;
generating a recipe catalog including recipes associated with the plurality of food items in the food inventory;
collecting consumption data associated with a rate at which food items are removed from the food inventory;
identifying, based on the consumption data and the anticipated expiration dates, that a food item of the plurality of food items in the food inventory is an expiring food item that will expire prior to being removed from the food inventory; and
generating, based on the identification of the expiring food item, a notification including the anticipated expiration date of the expiring food item and a recipe of the recipe catalog associated with the expiring food item.

13. The method of claim 12,
wherein the plurality of food items are stored in a food storage cabinet.

14. The method of claim 13, further comprising:
monitoring internal conditions of the food storage cabinet in which the plurality of food items are stored;
wherein identifying that the food item of the plurality of food items is the expiring food item is further based on the internal conditions of the food storage cabinet.

15. The method of claim 13,
wherein the food details include a food storage location associated with a location of the respective food item within the food storage cabinet.

16. The method of claim 12, further comprising
accessing food safety information associated with safe storage durations for each of the plurality of food items in the food inventory;
wherein each anticipated expiration date is based on the food safety information.

17. A food inventory management system, comprising:
a food storage cabinet;
a printer in wireless communication with one or more processors;
a scale in wireless communication with the one or more processors; and
a non-transitory computer readable medium having stored thereon a plurality of instructions, wherein the instructions are executed with the one or more processors so that the following steps are executed:
receiving a first input including a first food detail associated with a food item to be stored in the food storage cabinet, wherein the first food detail includes a food storage date;
receiving, from the scale, a second input including a second food detail associated with the food item to be stored in a food storage cabinet, wherein the second food detail includes a food weight;
generating a scannable code associated with the first and second food details and the food item;
transmitting the scannable code to the printer, wherein the scannable code is configured to be printed by the printer and subsequently affixed to the food item associated with the scannable code;
adding the food item to a food inventory;
scanning the scannable code to display the food details associated with the food item; and
removing the food item from the food inventory.

18. The system of claim 17, wherein the instructions are executed with the one or more processors so that the following additional steps are executed:
generating a notification associated with the food item; and
displaying the notification associated with the food item.

19. The system of claim 18,
wherein the notification includes a meal idea associated with the food item.

20. The system of claim 18,
wherein the notification is generated based on the food storage date associated with the food item; and
wherein the notification includes an expiration warning associated with the food item.
